(19) United States
(12) Patent Application Publication
(10) Pub. No.: US 2022/0165534 A1
(43) Pub. Date: May 26, 2022

(54) MAGNETRON

(71) Applicant: Teledyne UK Limited, Chelmsford (GB)

(72) Inventors: Mauro Mineo, Chelmsford (GB); Kesar Saleem, Ilford (GB); Daniel James Clay, Laindon (GB)

(21) Appl. No.: 17/455,725

(22) Filed: Nov. 19, 2021

(30) Foreign Application Priority Data
Nov. 26, 2020 (GB) 2018624.3

(51) Int. Cl. H01J 23/22; H01J 23/207; H01J 23/02

(52) U.S. Cl. CPC H01J 23/22; H01J 23/02; H01J 23/207

(57) ABSTRACT

There is provided an anode for a magnetron, the anode comprising: a cylindrical shell defining a longitudinal axis, a centre of the shell for accommodating a cathode of the magnetron; a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and a plurality of annular strap rings for setting a resonant mode spectrum of the cavity resonator, wherein the strap rings are arranged at longitudinal intervals and concentrically with the longitudinal axis of the shell, wherein alternate vanes are configured to support the alternate strap rings, such that each vane couples alternate strap rings and each strap ring couples alternate vanes, wherein a cross-sectional dimension of at least a first strap ring of the plurality of strap rings is different from the cross-sectional dimension of at least a second strap ring of the plurality of strap rings.

### FIELD OF THE INVENTION

The present disclosure relates to anodes for a magnetron, a plurality of strap rings thereof, a magnetron and methods of manufacturing anodes for a magnetron. The apparatus and methods may find particular application but not exclusively in the field of the generation of microwaves, for example, for use in a particle accelerator.

### BACKGROUND

A magnetron may be used to generate radio frequency (RF) energy (such as microwaves) for a variety of different purposes. For example, RF energy generated by a magnetron may be provided to a particle accelerator (such as a linear accelerator) and used to establish accelerating electromagnetic fields for the acceleration of charged particles, such as electrons. In some applications accelerated electrons may be directed to be incident on a target material (such as tungsten), which causes some of the energy of the electrons to be emitted as x-rays from the target material.

Generated X-rays may, in some applications, be used for medical imaging and/or treatment purposes. For example, x-rays may be directed to be incident on all or part of a patient's body and one or more sensors may be positioned to detect x-rays which are transmitted and/or reflected by the patient's body. Detected x-rays may be used to form an image of all or part of a patient's body which may be capable of resolving details of the internal structure of the body. X-rays may additionally or alternatively be directed to be incident on a particular part of a patient's body for treatment purposes. For example, x-rays may be directed to be incident on a tumour detected in the body in order to treat the tumour by destroying cancerous cells in the tumour.

Alternatively, accelerated electrons may be directed to be incident on a particular part of a patient's body (such as a tumour) for treatment purposes. For example, electrons output from a particle accelerator (such as a linear accelerator) may be collimated and directed to be incident on part of a patient's body.

In further applications a particle accelerator may be used to generate x-rays for non-medical purposes. For example, generated x-rays may be directed to be incident on a non-medical target to be imaged. One or more sensors may be positioned to detect x-rays which are transmitted by and/or reflected from the imaging target. The detected x-rays may be used to form an image capable of resolving the internal structure of the imaging target. X-ray imaging may find particular use in security related applications, since it is capable of resolving items which are otherwise concealed from view. For example, x-ray imaging may be used to image cargo from outside of a container in which the cargo is stored. X-ray images may be capable of resolving different objects which form part of the concealed cargo in order to identify the contents of the cargo.

Several applications of a magnetron have been described above in which generated RF energy is used to accelerate charged particles, such as electrons. However, magnetrons may find other applications such as for the generation of RF energy for use in radars.

It is in this context the present disclosure has been devised.

### SUMMARY OF THE INVENTION

In accordance with the present inventions there is provided an anode for a magnetron, the anode comprising: a cylindrical shell defining a longitudinal axis, a centre of the shell for accommodating a cathode of the magnetron; a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and a plurality of annular strap rings for setting a resonant mode spectrum of the cavity resonator, wherein the strap rings are arranged at longitudinal intervals and concentrically with the longitudinal axis of the shell, wherein alternate vanes are configured to support the alternate strap rings, such that each vane couples alternate strap rings and each strap ring couples alternate vanes, wherein a cross-sectional dimension of at least a first strap ring of the plurality of strap rings is different from the cross-sectional dimension of at least a second strap ring of the plurality of strap rings.

When the above-described anode is implemented in a magnetron, the power output of the magnetron in use may be increased compared to the power output of a conventional magnetron. By providing straps with different dimensions distributed along the length of the vanes, the RF field produced across the vanes of the anode may be more uniformly distributed across the length of the anode vanes, as compared with the prior art where each of the straps has the same dimension. Since the strength of the RF field generated in the magnetron may be relatively constant across the length of the vanes, this improves the effectiveness of the electrodynamic interaction process and reduces the risk of localised heating occurring along the vanes, which could otherwise affect the electromagnetic field generated in the magnetron. Accordingly, this improves the electrical properties of the vanes of the anode and enables the overall RF field across the magnetron to be more accurately and precisely controlled to improve the power output by the magnetron. Furthermore, since the risk of localised heating along the vanes is significantly reduced, this reduces the risk of the vanes eroding over time, thereby improving the life span of the magnetron. Compared to magnetrons of the prior art, the distributed strapping technique of the present disclosure enables the use of multiple straps having tailored dimensions, thus improving stability and power handling capabilities.

The cross-sectional dimension of the at least a first strap ring and the cross-sectional dimension of the at least a second strap ring may refer to a cross-sectional dimension of portions of the strap rings which extend between the vanes. In more detail, each strap ring includes first portions which extend between vanes with which they are in electrical contact with (each alternate vane) and second portions at which the strap ring is in direct contact with the vane. The second portions of the strap rings provide the electrical connections between the strap rings and each alternate vane for each strap ring (at the interface between the respective vanes and strap rings). The first portions of the strap rings provide the electrical connection between alternate vanes. A cross-sectional dimension of the first portions of the at least a first strap ring may be different to a cross-sectional dimension of the first portions of the at least a second strap ring. Accordingly a cross-sectional dimension of an electrical connection provided by a strap ring between alternate vanes may be different for different strap rings (i.e. is different for the at least a first strap ring and the at least a second strap ring). In at least some examples, a cross-sectional area of an electrical connection provided by a strap ring between alternate vanes may be different for different strap rings (i.e. is different for the at least a first strap ring and the at least a second strap ring).

At least an interval between a first pair of adjacent strap rings may be different from an interval between a second pair of adjacent strap rings. The strap rings may be distributed non-uniformly along the lengths of the vanes. By arranging the strap rings in this manner, this may produce a more uniformly distributed RF field across the length of the vanes as compared with the prior art, thereby improving the power output of a magnetron in which the anode is implemented, in use, as well as the life span and electrical properties of the magnetron.

A radius of at least one strap ring of the plurality of strap rings may be different from the radius of at least another strap ring of the plurality of strap rings. By arranging the strap rings in this manner, this may produce a more uniformly distributed RF field across the length of the vanes as compared with the prior art, thereby improving the power output of a magnetron in which the anode is implemented, in use, as well as the life span and electrical properties of the magnetron. The radius of a strap ring as described herein may refer to the radius of the strap ring as a whole (which may have a substantially ring-like shape) rather than a cross-sectional radius of a strap ring. That is, the radius of a strap ring as described herein may refer to the radius of the ring shape defined by the strap ring. The radius of a strap ring may be defined as a radial distance from the longitudinal axis to the central radial position of the ring.

The strap rings may have a cross-section that is at least one of substantially square and rectangular shaped. Strap rings with such cross-sectional profiles may improve ease of manufacture and assembly.

Strap rings having the same cross-sectional dimension may be arranged across the shell according to a predetermined arrangement, based on a cross-sectional dimension of each strap ring. In doing so, this further contributes to making the RF field generated across the length of the vanes more uniform, whilst also providing greater structural integrity by reducing localised heating. For example, the first strap ring may have a cross-sectional dimension that is greater than the second strap ring, wherein the first strap ring may be arranged toward a longitudinal end of the respective vanes. The second strap rings may be arranged more centrally along the length of the respective vanes than the first strap ring. Relatively thicker straps may be arranged toward the ends of the vanes, whilst relatively smaller straps may be arranged more centrally along the vanes.

The cross-sectional dimension of at least the first strap ring may be predetermined for causing a radio frequency, RF, field across a vane, when generated by the cathode of an activated magnetron, to be uniformly distributed across the length of the vane.

As explained above, each vane couples alternate strap rings and each strap ring couples alternate vanes. Accordingly the plurality of annular strap rings may be considered to include a first group of strap rings and a second group of strap rings, where the first group of strap rings couple a first subset of the vanes and the second group of strap rings couple a second subset of the vanes. Strap rings belonging to the first group of strap rings are arranged alternately with strap rings belonging the second group of strap rings. That is, each alternate strap ring belongs to the same group of strap rings.

According to at least some examples, a cross-sectional dimension of at least a first strap ring belonging to the first group of strap rings may be different from the cross-sectional dimension of at least a second strap ring belonging to the first group of strap rings. A cross-sectional dimension of at least a third strap ring belonging to the second group of strap rings may be different from the cross-sectional dimension belonging to at least a fourth strap ring belonging to the second group of strap rings. That is, the first group of strap rings and/or the second group of strap rings may include different strap rings having different cross-sectional dimensions. As explained above, the cross-sectional dimensions referred to herein may correspond with a cross-sectional dimension of at least a first portion of a strap ring which extends between alternate vanes and provides an electrical connection between the vanes. In at least some examples, the first group of strap rings and/or the second group of strap rings may include different strap rings (which provide electrical connections between alternate vanes) having different cross-sectional areas.

The cross-sectional dimension of the at least a first strap ring may be different from the cross-sectional dimension of the at least a second strap ring at least in a portion of the strap rings which extend between alternate anode vanes.

The plurality of annular strap rings may include a first group of strap rings coupled to a first subset of the vanes and a second group of strap rings coupled to a second subset of the vanes. The at least a first strap ring and the at least a second strap ring may belong to the same of the first or second group of strap rings.

According to a second aspect of the present disclosure, there is provided an anode for a magnetron, the anode comprising: a cylindrical shell defining a longitudinal axis, a centre of the shell for accommodating a cathode of the magnetron; a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and a plurality of annular strap rings for setting a resonant mode spectrum of the cavity resonator, wherein the strap rings are arranged at longitudinal intervals and concentrically with the longitudinal axis of the shell, wherein alternate vanes are configured to support alternate strap rings, such that each vane couples alternate strap rings and each strap ring couples alternate vanes, wherein an interval between a first pair of adjacent strap rings is different from an interval between a second pair of adjacent strap rings.

When the above-described anode is implemented in a magnetron, the power output of the magnetron in use may be increased. By providing non-uniformly distributed straps along the length of the vanes, the RF field produced across the vanes of the anode may be more uniformly distributed across the length of the anode vanes, as compared with when the straps are uniformly distributed across the magnetron. Since the strength of the RF field generated in the magnetron may be relatively constant across the length of the vanes, this reduces the risk of localised heating occurring along the vanes, which could otherwise affect the electromagnetic field generated in the magnetron. Accordingly, this improves the electrical properties of the vanes of the anode and enables the overall RF field across the magnetron to be more accurately and precisely controlled to improve the power output by the magnetron. Furthermore, since the risk of localised heating along the vanes is significantly reduced, this reduces the risk of the vanes eroding over time, thereby improving the life span of the magnetron. Compared to magnetrons of the prior art, the distributed strapping technique of the present disclosure enables the use of multiple straps having tailored dimensions, thus improving stability and power handling capabilities.

At least one of a cross-sectional dimension and a radius of at least a first strap ring of the plurality of strap rings may be different from the respective cross-sectional dimension and the radius of at least a second strap ring of the plurality of strap rings. By varying the cross-sectional dimensions (which may result in different cross-sectional areas) of the strap rings in this manner, this may produce a more uniformly distributed RF field across the length of the vanes as compared with the prior art, thereby improving the power output of a magnetron in which the anode is implemented, in use, as well as the life span and electrical properties of the magnetron.

As described above with reference to the first aspect, the cross-sectional dimensions referred to herein may correspond with a cross-sectional dimension of at least a first portion of a strap ring which extends between alternate vanes and provides an electrical connection between alternate vanes. As further described above, the radius of a strap ring as described herein may refer to the radius of the strap ring as a whole (which may have a substantially ring-like shape) rather than a cross-sectional radius of a strap ring. That is, the radius of a strap ring as described herein may refer to the radius of the ring shape defined by the strap ring. The radius of a strap ring may be defined as a radial distance from the longitudinal axis to the central radial position of the ring.

The first pair of adjacent strap rings may be arranged more centrally in the magnetron than the second pair of adjacent strap rings, wherein the interval between the first pair of adjacent strap rings is greater than the interval between the second pair of adjacent strap rings. In doing so, this further contributes to making the RF field generated across the length of the vanes more uniform, whilst also providing greater structural integrity by reducing localised heating.

The intervals between the strap rings may be predetermined for causing a radio frequency, RF, field across a vane, when generated by the cathode of an activated magnetron, to be uniformly distributed across the length of the vane. In doing so, this reduces localised heating, thereby reducing the risk of vane erosion. As explained above, each vane couples alternate strap rings and each strap ring couples alternate vanes. Accordingly the plurality of annular strap rings may be considered to include a first group of strap rings and a second group of strap rings, where the first group of strap rings couple a first subset of the vanes and the second group of strap rings couple a second subset of the vanes. Strap rings belonging to the first group of strap rings are arranged alternately with strap rings belonging the second group of strap rings. That is, each alternate strap ring belongs to the same group of strap rings.

According to at least some examples, an interval between a first pair of strap rings belonging to the first group of strap rings (and which are adjacent to each other in the first group) may be different from an interval between a second pair of strap rings belonging to the first group of strap rings (and which are adjacent to each other in the first group). An interval between a first pair of strap rings belonging to the second group of strap rings (and which are adjacent to each other in the second group) may be different from an interval between a second pair of strap rings belonging to the second group of strap rings (and which are adjacent to each other in the second group). That is, the first group of strap rings and/or the second group of strap rings may include different pairs of strap rings (which are adjacent to each other in that group) having different intervals between them.

According to a third aspect of the disclosure, there is provided an anode for a magnetron, the anode comprising: a cylindrical shell defining a longitudinal axis, a centre of the shell for accommodating a cathode of the magnetron; a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and a plurality of annular strap rings for setting a resonant mode spectrum of the cavity resonator, wherein the strap rings are arranged at longitudinal intervals and concentrically with the longitudinal axis of the shell, wherein alternate vanes are configured to support alternate strap rings, such that each vane couples alternate strap rings and each strap ring couples alternate vanes, wherein a radius of at least a first strap ring of the plurality of strap rings is different from the radius of at least a second strap ring of the plurality of strap rings.

When the above-described anode is implemented in a magnetron, the power output of the magnetron in use may be increased. By providing non-uniformly distributed straps along the length of the vanes, the RF field produced across the vanes of the anode may be more uniformly distributed across the length of the anode vanes, as compared with when the straps are uniformly distributed across the magnetron. Since the strength of the RF field generated in the magnetron may be relatively constant across the length of the vanes, this reduces the risk of localised heating occurring along the vanes, which could otherwise affect the electromagnetic field generated in the magnetron. Accordingly, this improves the electrical properties of the vanes of the anode and enables the overall RF field across the magnetron to be more accurately and precisely controlled to improve the power output by the magnetron. Furthermore, since the risk of localised heating along the vanes is significantly reduced, this reduces the risk of the vanes eroding over time, thereby improving the life span of the magnetron. Compared to magnetrons of the prior art, the distributed strapping technique of the present disclosure enables the use of multiple straps having tailored dimensions, thus improving stability and power handling capabilities.

As described above, the radius of a strap ring as described herein may refer to the radius of the strap ring as a whole (which may have a substantially ring-like shape) rather than a cross-sectional radius of a strap ring. That is, the radius of a strap ring as described herein may refer to the radius of the ring shape defined by the strap ring. The radius of a strap ring may be defined as a radial distance from the longitudinal axis to the central radial position of the ring.

A cross-sectional dimension of at least a first strap ring of the plurality of strap rings may be different from the cross-sectional dimension of at least a second strap ring of the plurality of strap rings. As described above, the cross-sectional dimensions referred to herein may correspond with a cross-sectional dimension of at least a first portion of a strap ring which extends between alternate vanes and provides an electrical connection between alternate vanes. An interval between a first pair of adjacent strap rings may be different from an interval between a second pair of adjacent strap rings.

The radius of at least the first strap ring may be predetermined for causing a radio frequency, RF, field across a vane, when generated by the cathode of an activated magnetron, to be uniformly distributed across the length of the vane.

As explained above, each vane couples alternate strap rings and each strap ring couples alternate vanes. Accordingly the plurality of annular strap rings may be considered to include a first group of strap rings and a second group of strap rings, where the first group of strap rings couple a first subset of the vanes and the second group of strap rings couple a second subset of the vanes. Strap rings belonging to the first group of strap rings are arranged alternately with strap rings belonging the second group of strap rings. That is, each alternate strap ring belongs to the same group of strap rings.

According to at least some examples, the radius of at least a first strap ring belonging to the first group of strap rings may be different from a radius of at least a second strap ring also belonging to the first group of strap rings. The radius of at least a third strap rings belonging to the second group of strap rings may be different from a radius of at least a fourth strap ring also belonging to the second group of strap rings. That is, the first group of strap rings and/or the second group of strap rings may include different strap rings having different radiuses.

The plurality of annular strap rings may include a first group of strap rings coupled to a first subset of the vanes and a second group of strap rings coupled to a second subset of the vanes. The at least a first strap ring and the at least a second strap ring may belong to the same of the first or second group of strap rings

According to a fourth aspect of the present disclosure, there is provided a plurality of strap rings for setting a resonant mode spectrum of a cavity resonator of a magnetron, wherein at least one of a cross-sectional dimension and a radius of at least a first strap ring of the plurality of strap rings is different from at least one of the respective cross-sectional dimension and the radius of at least a second strap ring of the plurality of strap rings.

As described above, the cross-sectional dimensions referred to herein may correspond with a cross-sectional dimension of at least a first portion of a strap ring which extends between alternate vanes and provides an electrical connection between alternate vanes. As further described above, the radius of a strap ring as described herein may refer to the radius of the strap ring as a whole (which may have a substantially ring-like shape) rather than a cross-sectional radius of a strap ring. That is, the radius of a strap ring as described herein may refer to the radius of the ring shape defined by the strap ring. The radius of a strap ring may be defined as a radial distance from the longitudinal axis to the central radial position of the ring.

According to a fifth aspect of the present disclosure, there is provided a magnetron comprising an anode as described herein.

According to a sixth aspect of the present disclosure, there is provided a method of manufacturing an anode for a magnetron, the method comprising: providing a cylindrical shell defining a longitudinal axis and having a centre for accommodating a cathode of a magnetron; providing a plurality of vanes arranged at angular intervals around the shell, wherein an angular separation between each vane and its adjacent vane is for providing a cavity resonator of the magnetron, wherein each vane has a width for extending radially inwardly from the shell toward the centre of the shell, and has a length for extending longitudinally in parallel with the longitudinal axis of the shell; and providing a plurality of annular strap rings for setting a resonant mode spectrum of the cavity resonator; arranging the strap rings within the shell at longitudinal intervals and concentrically with the longitudinal axis of the shell, wherein alternate vanes are configured to support the alternate strap rings, such that each vane couples alternate strap rings and each strap ring couples alternate vanes, wherein a cross-sectional dimension of at least a first strap ring of the plurality of strap rings is different from the cross-sectional dimension of at least a second strap ring of the plurality of strap rings.

The strap rings may be arranged according to a predetermined arrangement, based on a cross-sectional dimension of each strap ring. The first strap ring may have a cross-sectional dimension that is greater than the second strap ring, wherein the first strap ring may be arranged toward a longitudinal end of the respective vanes. The second strap rings may be arranged more centrally along the length of the respective vanes than the first strap ring.

The strap rings may be arranged to provide at least an interval between a first pair of adjacent strap rings that is different from an interval between a second pair of adjacent strap rings.

A radius of at least one strap ring of the plurality of strap rings may be different from the radius of another strap ring of the plurality of strap rings.

According to a seventh aspect of the present disclosure, there is provided a method of manufacturing an anode for a magnetron, the method comprising: providing a cylindrical shell defining a longitudinal axis and having a centre for accommodating a cathode of a magnetron; providing a plurality of vanes arranged at angular intervals around the shell, wherein an angular separation between each vane and its adjacent vane is for providing a cavity resonator of the magnetron, wherein each vane has a width for extending radially inwardly from the shell toward the centre of the shell, and has a length for extending longitudinally in parallel with the longitudinal axis of the shell; and providing a plurality of annular strap rings for setting a resonant mode spectrum of the cavity resonator; arranging the strap rings within the shell at longitudinal intervals and concentrically with the longitudinal axis of the shell, wherein alternate vanes are configured to support the alternate strap rings, such that each vane couples alternate strap rings and each strap ring couples alternate vanes, wherein at least an interval between a first pair of adjacent strap rings is different from an interval between a second pair of adjacent strap rings.

A cross-sectional dimension of at least a first strap ring of the plurality of strap rings may be different from the cross-sectional dimension of at least a second strap ring of the plurality of strap rings.

The first pair of adjacent strap rings may be arranged more centrally in the magnetron than the second pair of adjacent strap rings, wherein the interval between the first pair of adjacent strap rings is greater than the interval between the second pair of adjacent strap rings.

According to an eighth aspect of the present disclosure, there is provided a method of manufacturing an anode for a magnetron, the method comprising: providing a cylindrical shell defining a longitudinal axis and having a centre for accommodating a cathode of a magnetron; providing a plurality of vanes arranged at angular intervals around the shell, wherein an angular separation between each vane and its adjacent vane is for providing a cavity resonator of the magnetron, wherein each vane has a width for extending radially inwardly from the shell toward the centre of the shell, and has a length for extending longitudinally in parallel with the longitudinal axis of the shell; and providing a plurality of annular strap rings for setting a resonant mode spectrum of the cavity resonator; arranging the strap rings within the shell at longitudinal intervals and concentrically with the longitudinal axis of the shell, wherein alternate vanes are configured to support the alternate strap rings, such that each vane couples alternate strap rings and each strap ring couples alternate vanes, wherein a radius of at least a first strap ring of the plurality of strap rings is different from the radius of at least a second strap ring of the plurality of strap rings.

Each strap ring may be provided with at least one break for threading each strap ring through apertures of the respective vanes. This may be particularly beneficial for quick and efficient assembly of the anode.

Each strap ring may be integrally formed.

The method may further comprise brazing the arranged strap rings and vanes together. The method may further comprise brazing the vanes to the inner wall of the shell.

In any of the aspects and/or examples described herein, each strap ring may have a substantially uniform cross-section around the entirety of the strap ring. That is, a cross-sectional dimension, profile and/or cross-sectional area of a strap ring may be substantially constant around the entire strap ring.

In any of the aspects and/or examples described herein, each of the strap rings may be arranged such that they are enclosed by each vane as they pass through the vane. For example, the vanes may include holes through which the strap rings pass, where the strap rings are completely enclosed by the holes at the point at which they pass through the vanes. The vanes may include a hole for each strap ring such that only a single strap ring is positioned in each hole in the vane. Each vane may include a first group of holes for a first group of strap rings and a second group of holes for a second group of strap rings. In each vane, one of the first and second group of holes may be dimensioned such that the vane is in electrical contact with the strap rings passing through those holes. The other of the first and second group of holes may be dimensioned such the strap rings passing through those holes are not in electrical contact with the vane at those holes. Holes belonging to the first group of holes may alternate with holes belonging to the second group of holes along the anode vane. In this way, the vane couples alternate strap rings through electrical contact with alternate strap rings.

By providing vanes which enclose the strap rings as they pass through the vanes, the strap rings are only exposed to the cathode at the gaps between the anode vanes. Strap rings which are exposed at either end of an anode vane may therefore be avoided. Strap rings which are exposed at either end of an anode vane may risk unstable operation of a magnetron.

As described above, a plurality of strap rings may be arranged such that one or more of a cross-sectional dimension of a strap ring, a radius of a strap ring and an interval to an adjacent strap ring is different for different strap rings. As a result of such an arrangement, a capacitance between a given strap ring and other strap rings in the anode (e.g. between a strap ring and an adjacent strap ring) may be different for different strap rings. Additionally or alternatively a capacitance between a given strap ring and another component of the anode (such as an anode vane) may be different for different strap rings. That is, a capacitance between different respective components of the anode may vary along the length of the anode as a result of variations in the strap rings as described herein (e.g. cross-sectional dimension, radius and/or intervals between strap rings). Such variations in capacitances may be used to provide an arrangement which serves to smooth the RF field distribution along the anode.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention are shown schematically, by way of example only, in the accompanying drawings, in which:

FIG. 1A is a schematic illustration of a magnetron of a type contemplated herein;

FIG. 1B is a schematic illustration of a cross-section taken through the magnetron illustrated in FIG. 1A;

FIG. 2A is a schematic illustration of a magnetron including a tuning assembly;

FIG. 2B is a schematic illustration of a cross-section taken through the magnetron illustrated in FIG. 2A;

FIG. 3 is a schematic illustration of a magnetron according to a first example of the disclosure;

FIG. 4 is a schematic representation of the amplitude of the RF field distribution across a vane in its longitudinal direction with different sets of strap rings;

FIG. 5 is a schematic illustration of a magnetron according to a second example of the disclosure;

FIG. 6 is a schematic illustration of a magnetron according to a third example of the disclosure;

FIG. 7 is a flow chart according to a first method of the disclosure; and

FIG. 8 is a flow chart according to a second method of the disclosure.

Throughout the description and the drawings, like reference numerals refer to like parts.

### DETAILED DESCRIPTION

Before particular examples of the present invention are described, it is to be understood that the present disclosure is not limited to the particular embodiments described herein. It is also to be understood that the terminology used herein is used for describing particular examples only and is not intended to limit the scope of the claims.

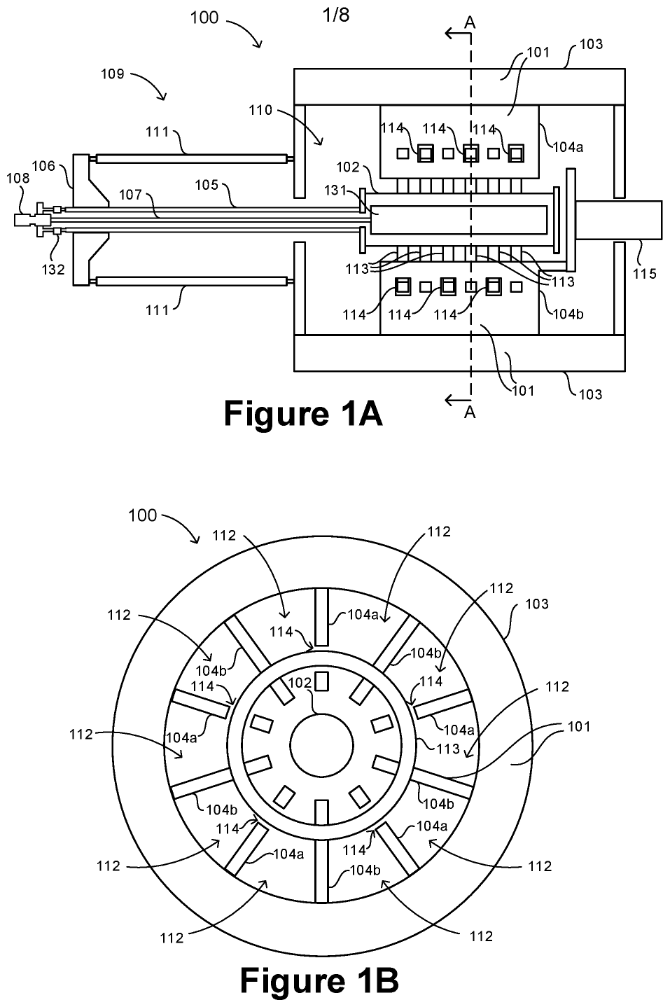

FIGS. 1A and 1B are schematic illustrations of an example magnetron 100 of a type contemplated herein. FIG. 1A shows a longitudinal cut-plane through the magnetron 100 and FIG. 1B shows a cross-section through the magnetron 100 taken at the plane A-A indicated in FIG. 1A.

The magnetron 100 includes an anode 101 and a cathode 102. The example anode 101 shown in FIGS. 1A and 1B includes a generally cylindrical anode wall 103 and a plurality of anode vanes 104 extending inwards from the anode wall 103. As will be described in further detail below, the anode vanes may comprise a first group of anode vanes 104a and a second group of anode vanes 104b.

The cathode 102 is situated at least partially inside the anode 101 and is held in position relative to the anode 101 including the anode vanes 104. The cathode 102 is supported and held in position relative to the anode 102 by a support arm 105. The support arm 105 is fixed in place at an end distal the cathode 102 by a support structure 106 so as to form a cantilever supporting the cathode 102.

The cathode 102 and at least an internal portion of the anode 101 (e.g. the volume inside the anode wall 103) are located inside a vacuum envelope 110. Similarly to other vacuum electron devices, in order to generate RF energy, the volume inside the vacuum envelope 110 is pumped to vacuum pressure conditions.

In addition to supporting the cathode 102 and holding the cathode 102 in position relative to the anode 101, the support arm may also provide electrical connection to the cathode 102 and a heater 131, which is generally included in the cathode 102. In the depicted example, an electrical connection may be established through the support arm 105 (e.g. an external casing forming the support arm 105) and to the cathode 102. The support arm 105 may be electrically connected to the support structure 106. The support structure 106 comprises electrically conductive material (e.g. copper) electrically coupled to the support arm 105 and may serve as a connection terminal for establishing electrical connection to the cathode 102. In the depicted example, the support arm 105 further includes an electrical connection 107 (which may extend internally along the support arm 105 as shown in FIG. 1A) extending between the heater 131 and a connection terminal 108. The heater 131 may, for example, comprise a filament and may be configured to heat the cathode 102 (e.g. to promote thermionic emission of electrodes from the cathode 102). The connection terminal 108 is electrically isolated from the casing of the support arm 105 and the support structure 106 by an electrically insulating member 132.

The connection terminal 108 and/or the support structure 106 may be arranged for connection to a power supply (not shown) such as a DC power supply (which may, for example, comprise a pulsed DC power supply), in order to provide electrical connection between the power supply and the cathode 102 and/or the heater 131. In practice, the cathode 102 may be held at a voltage of several kilovolts (with respect to the anode 101). For example, the support structure 106 may be electrically connected to an external power supply (not shown) in order to establish a voltage (through the support structure 106 and the support arm 105) between the cathode 102 and the anode 101.

The heater 131 may comprise a resistive element through which an electric current is passed in order to generate resistive heating. In such examples, the heater 131 may comprise two electrical terminals between which a heating current flows. The first terminal may be the connection terminal 108 and the second terminal may be a connection between the heater 131 and the cathode 102 (connection not shown). The connection terminal 108 may be held at a potential difference (of, for example, several volts) with respect to the cathode 102 in order to promote a heater current to flow through the heater 131.

The support arm 105 extends along a section 109 of the magnetron which may be referred to as a side arm 109. In the depicted example, the side arm 109 forms part of the vacuum envelope 110 and thus the internal volume of the side arm 109 may be pumped to vacuum pressure conditions. In the depicted example, the external structure of the side arm 109 is defined by the support structure 106 and a casing 111 extending between the support structure 106 and the anode 101. The casing 111 may be formed of an electrically insulating or dielectric material such as a ceramic.

The side arm 109 may function to provide a hold off distance between the anode 101 and a connection terminal 108 and the support structure 106 located substantially at an end of the side arm 109 distal the cathode 102 and the anode 101. Since, the support structure 106 may be used to establish a voltage difference between the anode 101 and the cathode 102 there may a relatively high voltage between the support structure 106 and the anode 101 and/or other components of the magnetron. For example, during operation, the anode 101 may be electrically grounded and the cathode 102, via the support structure 106, may be held at a high voltage. For example, a voltage difference of several kilovolts (e.g. a voltage difference of 3 kV or more) may be provided between the cathode 102 and the anode 101. Due to the relatively high voltages used, components of the magnetron may be arranged to reduce a risk of electrical breakdown and arcing between components.

Voltage hold-off requirements in air are generally much more stringent than those in vacuum pressure conditions (e.g. by a factor of approximately eight). Suitable voltage hold-off between, for example, the anode 101 and the support structure 106 through air may be achieved through design of the casing 111 (which may comprise a dielectric material). For example, the shape and length of the casing 111 may be designed to reduce the risk of particle tracking along the casing 111 (which may lead to electrical breakdown between the support structure 106 and the anode 101). It may be possible to provide complex casing 111 shapes which can be used to reduce the length of the side arm 109 whilst maintaining suitable voltage hold-off. However, these may be complex and/or expensive and a simple cylindrical (or other simple shape) casing 111 may be used. In general, for a given shaped casing 111, there may be a minimum length of the side arm 109 which is needed in order to provide sufficient voltage hold-off between the support structure 106 and the anode 101.

The magnetron 100 further includes an output 115 for coupling RF energy generated during operation of the magnetron 100 out of the magnetron 100. The output 115 may comprise any suitable structure for coupling the magnetron 100 to one or more components (not shown) external to the magnetron 100 (such as a particle accelerator) for providing RF energy to the one or more external components. Whilst not shown in the Figures, the magnetron 100 may further comprise an output window through which the generated RF energy is output whilst isolating the vacuum envelope 110 from the external environment.

As was mentioned above, during operation of the magnetron 100, a voltage (which may be a high voltage, for example of several kilovolts) may be applied between the anode 101 and the cathode 102. In particular examples contemplated herein the anode 101 may be electrically grounded and the cathode 102 may be held at a high voltage with respect to the grounded anode 101.

The cathode 102 is configured to emit electrons, for example (but not necessarily) by thermionic emission, which are drawn towards the anode by virtue of the voltage maintained between the cathode 102 and the anode 101. As was mentioned above, the cathode 102 may be heated in order to promote thermionic emission of electrons from the cathode 102. The emission properties of the cathode 102 may be driven by the temperature and the material properties of the emitting surface of the cathode 102.

As shown in FIG. 1B, the anode 101 includes a plurality of anode vanes 104 which define an even number of cavities 112 therebetween. Whilst not shown in the Figures, the magnetron 100 is subjected to a magnetic field running substantially parallel with the magnetron axis (left-to-right in FIG. 1A and into and out of the page in FIG. 1B). The magnetic field may be generated by any suitable arrangement of one or more permanent magnets and/or electromagnets.

An electron cloud emitted from the cathode 102 is subject to both the electric field established between the anode 101 and the cathode 102 (by virtue of the voltage between them) and the magnetic field established in the magnetron. The combined effect of these fields is to cause a rotation of electrons around an interaction region between the anode 101 and the cathode 102. The rotation of the electron cloud past the cavities 112 induces an RF electromagnetic field which serves to excite resonant modes of the cavities 112. By inducing the RF field, the electron cloud may excite resonant modes of the cavity resonators based on the angular velocity of the electrons. This in turn may cause electrons to accelerate or decelerate due to the RF field at the anode 101, depending on the relative phase. As the electrons move across the vanes 104, a positive feedback effect may be created whereby the resonant-modes increase in energy. In practice, this may deform the electron cloud to undergo a spoked wheel effect (or space-charge wheel).

Interaction between the electron cloud and the anode 101 can occur through any of the resonant-modes supported by the anode 101. In practice, the most effective mode for producing useful RF power in a magnetron is referred to as a π-mode, in which the oscillations in each cavity 112 of the anode 101 are substantially 180° (πradians) out of phase with the oscillations in each immediately adjacent cavity 112. That is, in the π-mode each alternate cavity 112 in the magnetron oscillates substantially in phase with each other.

In some magnetrons, the separation between the π-mode frequency and the frequency of other resonant modes is too small to ensure stable operation of the magnetron. In order to separate the π-mode frequency from other resonant modes, a technique referred to as anode strapping may be used. In the magnetron depicted in FIGS. 1A and 1B the anode includes a plurality of anode straps/strap rings 113 extending around the anode 101 and between the anode vanes 104. As can be seen, for example, from FIG. 1B, each anode strap 113 is in electrical contact with each alternate anode vane 104 and passes through a suitably arranged aperture 114 in every other anode vane 104. For example, in the cross-section shown in FIG. 1B, the anode strap 113 passes through apertures/holes 114 positioned in a first group of anode vanes 104a and is in electrical contact with each of a second group of anode vanes 104b. As can be seen in FIG. 1A other anode straps 103 are arranged to be in electrical contact with each of the first group of anode vanes 104a and to pass through apertures 114 located in the second group of anode vanes 104b. The vanes 104 thus support the anode straps/strap rings 113 such that each vane couples alternate straps 113 and each strap couples alternate vanes. By electrically connecting alternate anode vanes 104, the π-mode frequency may be separated from the frequency of other resonant modes.

In some applications of a magnetron 100, it may be desirable to vary one or more parameters of the magnetron's output during operation of the magnetron. For example, it may be desirable to vary a frequency (and thus also wavelength) of the RF energy generated by the magnetron 100 (typically within a given frequency band). In particular, it may be desirable to vary the frequency of the resonant π-mode generated by the magnetron 100. In applications in which the RF energy generated by the magnetron 100 is used to drive a particle accelerator (e.g. a linear accelerator), the frequency of the magnetron 100 may be varied in order to match the frequency of the accelerator, which may itself vary during operation. In general, the frequency of the magnetron 100 may be varied in order to match the requirements of the system in which the magnetron 100 operates (for example, to align with one or more sub-systems driven by the output of the magnetron 100).

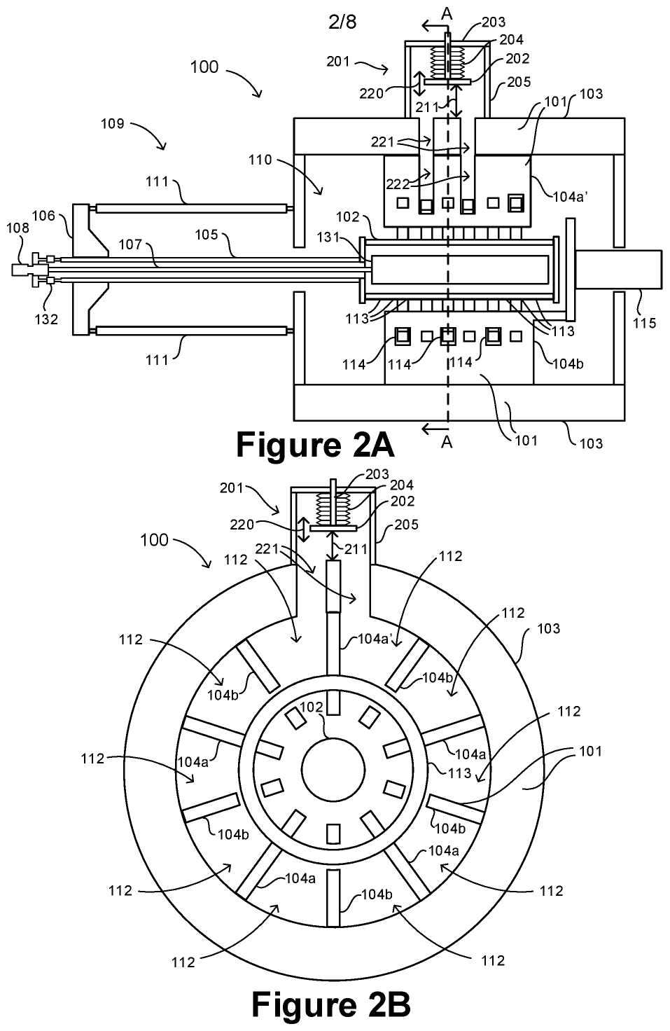

FIGS. 2A and 2B are schematic illustrations of an example magnetron 100 including a tuning assembly 201. Similarly to FIGS. 1A and 1B, FIG. 2A shows a longitudinal cut-plane through the magnetron 100 and FIG. 2B shows a cross-section through the magnetron 100 taken at the plane A-A indicated in FIG. 2A. The magnetron 100 illustrated in FIGS. 2A and 2B includes many of the same components and properties as those described above with reference to FIGS. 1A and 1B and the same reference numerals have been used in FIGS. 1A, 1B, 2A and 2B to denote corresponding components. Accordingly, a detailed description of corresponding components is not provided with reference to FIGS. 2A and 2B.

In general, the resonant mode spectrum of the anode 101 is dependent on the geometry of the anode cavities 112 and their relative arrangement. The tuning assembly 201 depicted in FIGS. 2A and 2B comprises a resonant structure coupled to the anode 101 and having its own resonant frequency spectrum. The resonant frequency spectrum of the tuning assembly 201 may be characterised by a natural resonant frequency which corresponds with the fundamental mode of the resonant frequency spectrum of the tuning assembly 201. The coupling between the anode 101 and the resonant tuning assembly 201 means that the resonant mode spectrum of the anode 101 is dependent both on the geometry of the anode cavities 112 and on the natural resonant frequency of the resonant tuning assembly 201, as well as the degree of coupling between the anode 101 and the tuning assembly 201. The tuning assembly 201 is arranged to allow for the resonant frequency of the tuning assembly 201 to be varied through movement of one or more components of the tuning assembly 201. As a consequence of the coupling between the tuning assembly 201 and the anode 101, the resonant mode spectrum of the anode 101 may be varied by varying the natural resonant frequency of the tuning assembly 201. For example, the tuning assembly 201 may be used to vary the frequency of the π-mode generated by the magnetron.

The tuning assembly 201 includes a tuning member 202, a movement mechanism 203, a sealing structure 204 and a casing 205. The tuning member 202 comprises an arrangement of electrically conductive material configured such that movement of the tuning member 202 brings about a variation in the resonant frequency of the tuning assembly 201. In the depicted example, the tuning member 202 comprises an electrically conductive plate 202. The tuning member 202 is separated from at least a portion of the anode 101 by a capacitive gap 211. The capacitance across the gap 211 is a function of the length of the gap 211, which is varied by movement of the tuning member 202. Movement of the tuning member 202 therefore causes a variation in the capacitance of the tuning assembly 201 which brings about a corresponding variation in the natural resonant frequency of the tuning assembly 201. The tuning member 202 may comprise any suitable electrically conductive material such as copper.

The movement mechanism 203 is configured to move the tuning member 202, for example, relative to the anode 101. For example, the movement mechanism 203 may be configured to move the tuning member 202 towards and/or away from the anode 101 as depicted by the double-headed arrows labelled 220 in FIGS. 2A and 2B. As was explained above, such movement of the tuning member 202 may cause a corresponding variation in the capacitance (and in turn the resonant frequency) of the tuning assembly 201. In the depiction shown in FIGS. 2A and 2B, the movement mechanism 203 is represented by a single moveable part 203 attached to the tuning member 202. Movement of the moveable part 203 (e.g. in the directions shown by the arrows 220) brings about corresponding movement of the tuning member 202. The movement mechanism 203 may further comprise any suitable actuator (not shown) for driving movement of tuning member 202 (e.g. by driving movement of the movable part depicted in FIGS. 2A and 2B).

In the arrangement depicted in FIGS. 2A and 2B, the anode wall 103 includes cut-outs 221 and the anode vane 104a′ around which the tuning assembly 201 is situated includes cut-outs 222. The arrangement of the tuning assembly 201 relative to the anode 101 (e.g. the anode vane 104a′) may determine the degree of coupling between the resonant tuning assembly 201 and the anode 101. As a result, at least of the cut outs 221 in the anode wall 103, the tuning member 202 is at least partially situated inside the vacuum envelope 110, which extends into the casing 205 of the tuning assembly 201.

The sealing structure 204 is configured to seal at least part of the movement mechanism 203 from the vacuum envelope 110. For example, the sealing structure 204 may provide a hermetic seal around at least part of the movement mechanism 203. The sealing structure 204 may comprise a flexible interface configured to accommodate movement of the the movement mechanism 203 whilst maintaining the seal around the movement mechanism 203. In the depicted example, the sealing structure 204 is arranged in the form of bellows which expand and contract to accommodate movement of the tuning mechanism 203.

Whilst a particular design of a tuning assembly has been described above with reference to FIGS. 2A and 2B, in general any suitable tuning assembly may be used in order to vary the resonant frequency of the magnetron 100. For example, any suitable resonant structure having a variable resonant mode spectrum and coupled to the anode 101 may be used to form a resonant tuning arrangement. Whilst a resonant tuning arrangement has been described above, in alternative examples the resonant frequency of the cavities 112 (and hence the frequency of the magnetron 100) may be varied by varying the capacitance and/or the inductance of the cavities 112 themselves. Such arrangements may be referred to as capacitive and/or inductive tuners.

As shown in FIGS. 1A and 2A, the strap rings 113 generally each having the same dimensions and cross-sectional geometry. The inventors however have realised that providing each strap ring 113 having identical geometric dimensions can cause the magnetron 100 to generate RF fields that are not uniformly distributed along the lengths of the vanes 104a, 104b of the anode 101. In particular, the inventors have investigated the RF field generated and found that this leads to an RF field that is highly concentrated in a central region of the anode, and with weaker RF fields at the longitudinal ends of the anode. Since the RF field is not uniformly distributed down the lengths of the vanes 104a, 104b, this risks causing localised heating on regions of the vanes 104a, 104b where the RF field is highly concentrated. The inventors have found that such localised heating can cause the vanes to erode at those regions, thereby affecting the stability of the operating anode mode and their electrical properties to reduce the strength of the resulting RF fields, and in turn the power output by the magnetron. In particular, the inventors have realised the electromagnetic field may not be as accurately or precisely as predicted produced by the anode due to the non-uniform distribution down the lengths of the vanes 104a, 104b.

Furthermore, as shown in FIGS. 1A and 2A, the strap rings 113 are generally evenly distributed along the lengths of the vanes 104a, 104b. The inventors have realised that uniformly distributing the strap rings 113 along the vanes 104a, 104b can also cause the magnetron 100 to generate RF fields that are not uniformly distributed along the lengths of the vanes 104a, 104b of the anode 101, which in turn can lead to localised heating at the highly concentrated regions of the RF field at the vanes, thereby risking the vanes being eroded and reduced power output by the magnetron for the same reasons discussed above.

One approach of overcoming unacceptable variation of the RF field along the lengths of the magnetron is to increase the length of the anode. The inventors however have realised that increasing the size of the magnetron leads to the anode including more resonant cavities, which in turn changes the mode spectrum of the anode cavity such that the fundamental mode of operation risks becoming unstable. Furthermore, a longer magnetron anode may cause the magnetic circuit to be more costly and also significantly increase its size.

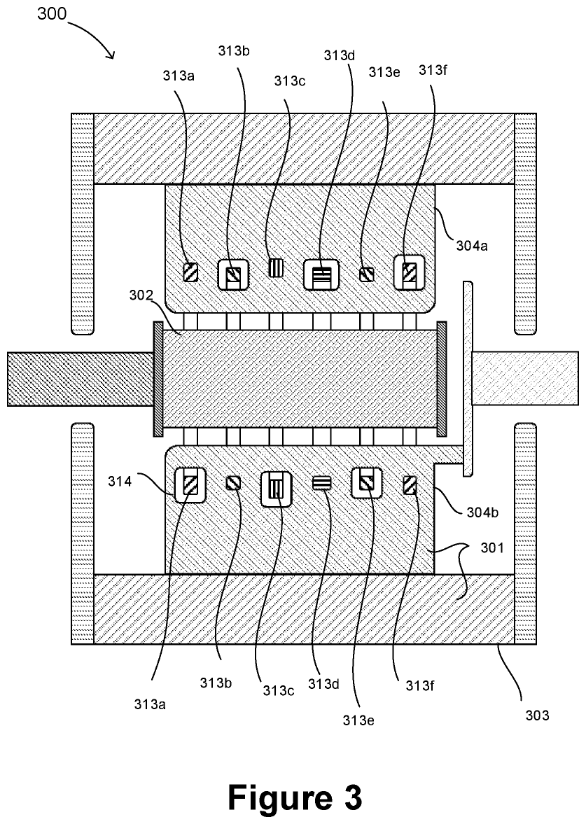

FIG. 3 shows a schematic illustration of a magnetron 300 according to a first example of the disclosure. The magnetron 300 comprises an anode 301 and a cathode 302. The cathode 302 may be substantially the cathode 102 of FIGS. 1A to 2A.

The anode 301 comprises a cylindrical shell 303, a plurality of vanes 304a, 304b, and a plurality of straps or strap rings 313a, 313b, 313c, 313d, 313e, 313f (referred collectively together as strap rings 313). “Cylindrical” as used herein is understood to mean generally/substantially cylindrical. The shell 303 defines a longitudinal axis (left to right in FIG. 3) that may substantially coincide with the magnetron axis. The shell 303 may be the anode wall 103 described in relation to FIGS. 1A to 2B. The vanes are provided as a first group of vanes 304a and a second group of vanes 304b, each of which are arranged to extend inwardly from and at angular intervals around the shell 303. “Angular intervals” may be understood to mean that an azimuthal separation is provided between each vane and its adjacent vane. The first group of vanes 320a alternates angularly with the second group of vanes 320b, as shown in FIG. 3. The angular separations arising from the intervals between each vane 320a, 320b define an even number of resonant cavities around the shell 310. The vanes 320a, 320b include a plurality of holes 314 through which the strap rings 313 pass. In particular, the strap rings 313 are arranged at longitudinal intervals and concentrically with the longitudinal axis of the shell 303, and pass through the vanes 304a, 304b, so as to electrically connect alternately arranged vanes. By passing through the holes of the vanes, the strap rings are effectively encased by the vanes so that in use, the strap rings are only exposed to the cathode as they pass through the cavity resonators. By encasing the strap rings in this way, this reduces the risk of corruption to the desired Tr-mode frequency in the cavity resonators, thereby enabling greater accuracy and precision of setting the frequency of the resonant cavities by the strap rings.

The first vanes 304a include a plurality of holes 314 arranged at intervals longitudinally down the elongate axis of the vanes 204a, as shown in FIG. 3. The holes 314 include first holes and second holes that alternate with one another. The alternately arranged first holes are dimensioned to have a cross-sectional shape approximately corresponding to the cross-sectional shape of the strap ring passing therethrough, so as to facilitate electrical contact between that strap ring and the vane through which it is passing. The remaining second holes that alternate with the first holes are dimensioned to have cross-sectional shapes bigger than the cross-sectional shape of the strap ring passing therethrough, such that the strap rings are arranged to pass through the second holes without contacting the respective vane as they pass therethrough, to provide no coupling therebetween. As shown in FIG. 3, this arrangement of holes 314 enables the first vanes 304a to be electrically connected to one another by the alternately arranged strap rings 313a, 313c, 313e, whilst the first vanes 304a make no electrical contact with the strap rings 313b, 313d, 313f, by virtue of the holes 314. Similarly, the second vanes 304b are each coupled to one another by alternately arranged strap rings 313b, 313d, 313f, whilst the second vanes 304b make no electrical contact with the strap rings 313a, 313c, 313e, by virtue of the holes 314. Each of the first vanes 304a and second vanes 304b may be approximately as long as the length of the cathode 302.

As can be seen in the example of FIG. 3, and in the other examples, depicted and described herein, the annular strap rings 313 may be enclosed within the anode vanes at the position at which they pass through the anode vanes 304a, 304b. By providing vanes 304a, 304b, which enclose the strap rings 313 as they pass through the vanes 304a, 304b, strap rings which are exposed at either end of an anode vane 304a, 304b may be avoided. Strap rings which are exposed at either end of an anode vane 304a, 304b may risk unstable operation of the magnetron.

As can also be seen in the example of FIG. 3, and in the other examples, depicted and described herein, each strap ring 313 may have a substantially uniform cross-section around the entirety of the strap ring 313. That is, a cross-sectional dimension and/or cross-sectional area of a strap ring 313 may be substantially constant around the entire strap ring 313.

In the first example of the disclosure, at least one of the strap rings has a different geometric dimension to the geometric dimension of the other strap rings, such as a different cross-sectional shape and/or a different radius to the respective cross-sectional shape and/or radius of the other strap rings. It is noted that FIG. 3 is not to scale. In the specific example shown in FIG. 3, strap rings 313a and 313f have a first cross-sectional profile that is substantially rectangular and have a first radius, whilst strap rings 313b and 313e have a second cross-sectional profile that is substantially square-shaped and may have the first radius of the strap rings 313a, 313f. Strap ring 313c may have the first cross-sectional profile of strap rings 313a, 313f, but has a second radius that is greater than the first radius of strap rings 313a, 313b, 313e and 313f. Strap ring 313d has a third cross-sectional profile that has a rectangular profile having a different orientation to the orientation of the rectangular first and second cross-sectional profiles, and may have a third radius different to the first and second radii of the other strap rings. As such, each strap ring may have a predetermined cross-sectional profile and radius. However, it will be understood that the disclosure is not limited to this, and one or more of the straps rings may have a different cross-sectional profile from the other strap rings and/or one or more of the strap rings may have a different radius from the other strap rings. Moreover, the dimensions of the holes 314 will be tailored and predetermined according to the cross-section of the strap rings 313. In the specific example of FIG. 3, the strap rings 313 are uniformly arranged across the length of the magnetron 300, so that each strap ring is separated from its adjacent strap ring by the same separation distance.

In the example shown in FIG. 3, (and in the other examples, described and depicted herein), the strap rings 313 may be considered to belong to one of two groups, where each strap ring belonging to the same group of strap rings is in electrical contact with the same alternate anode vanes. That is, the first group of strap rings are in electrical contact with a first group of anode vanes 304a and the second group of strap rings are in electrical contact with a second group of anode vanes 304b. The strap rings 313a, 313c, 313e which are shown to be in contact with the anode vane 304a depicted in the upper half of FIG. 3 might be considered to belong to a first group of strap rings. The strap rings 313b, 313d, 313f which are shown to be in contact with the anode vane 304b depicted in the lower half of FIG. 3 might be considered to belong to a second group of strap rings. In at least some examples, at least one of the strap rings belonging to each group of strap rings may have a different cross-sectional profile and/or area to at least one other strap ring belonging to the same group of strap rings. For example, the strap ring 313a belonging to the first group of strap rings has a different radius or cross-sectional profile to the strap rings 313c, 313e which also belong to the same group of strap rings.

By providing strap rings with different geometric dimensions distributed along the length of the vanes, the RF field produced across the vanes of the anode during operation in a magnetron may be more uniformly distributed across the length of the anode vanes, as compared with the prior art where each of the straps has the same dimension. Since the strength of the RF field generated in the magnetron may be relatively constant across the length of the vanes, this advantageously reduces the risk of localised heating occurring along the vanes. Accordingly, this improves the electrical properties of the vanes of the anode and enables the overall RF field across the magnetron to be more accurately and precisely controlled to improve the power output by the magnetron. Furthermore, since the risk of localised heating along the vanes is significantly reduced, this reduces the risk of the vanes eroding over time, thereby improving the life span of the magnetron. Compared to magnetrons of the prior art, the distributed strapping technique of the present disclosure enables the use of multiple straps having tailored dimensions, thus improving stability and power handling capabilities.

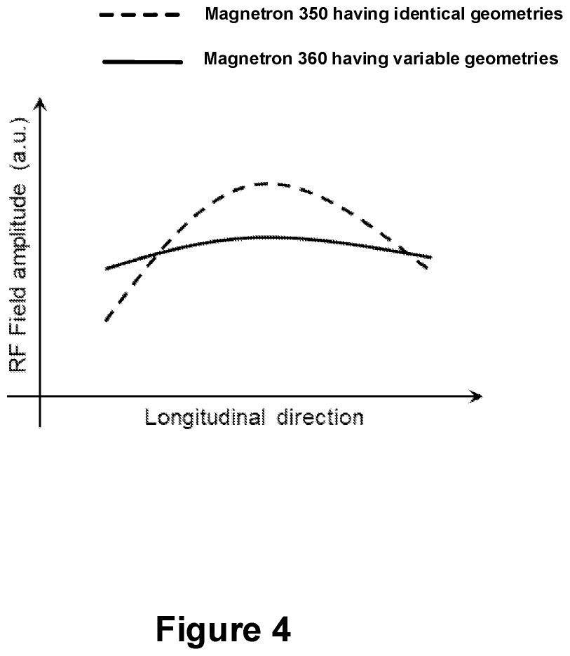

This is particularly illustrated in FIG. 4, which qualitatively illustrates the RF field across the length of a magnetron during operation, and compares the RF field of a magnetron 350 (e.g. a magnetron as illustrated in FIGS. 1A, 1B, 2B and 2B) having strap rings that are each identical geometrically (indicated by the dotted line), and a magnetron 360 having at least one strap ring that has a different geometric dimension to the geometric dimension of the other strap rings (indicated by the solid line), such as the magnetron 300 of FIG. 3 having strap rings 313 with varying cross-sectional profiles (and/or areas) and/or radii. In particular, FIG. 4 shows that the RF field peaks in the middle of the magnetron 350 where the RF field concentrates approximately centrally therein. However, by including strap rings having different geometries, the RF field generated in use is substantially more uniform across the magnetron 360.

In the specific example of FIG. 3, there is also an element of symmetry along the longitudinal axis of the vanes 304a, 304b, with strap rings having the same cross-sectional profile being arranged at opposite ends of the vane. For example, strap rings 313a and 313f having the first cross-sectional profile and first radius are arranged at distal ends of the vanes 304a, 304b. In particular, the first cross-sectional profile (and correspondingly its cross-sectional area) of strap rings 313a, 313f is bigger than the second cross-sectional profile of strap rings 313b, 313e. In doing so, strap rings 313a, 313f having a bigger cross-sectional profile (and area) are arranged away from the centre of the vanes 304a, 304b, whilst strap rings 313b, 313e having a smaller cross-sectional profile (and area) are arranged more centrally along the lengths of the vanes 304a, 304b. This advantageously smooths the RF field along the lengths of the vanes 304a, 304b that would otherwise be concentrated centrally with respect to the vanes. As such, the vanes do not experience the same regions of concentrated RF fields that can cause them to overheat, thereby reducing the risk of the vanes eroding and improve the electromagnetic field produced for greater power output by the magnetron in use.

The disclosure is however not limited to the magnetron 300 shown in FIG. 3. It will be understood that the strap rings 313 may have any suitable cross-sectional shape and radius, and be tailored and pre-determined to smooth the RF field across the vane in use according to the frequency range and/or power of the magnetron. In the specific embodiment of FIG. 3, the magnetron is operable to generate microwaves having frequencies in the S band (about 2 to 4 GHz), and the cross-sectional length of the strap rings 313 may be up to 5 mm. It will however be understood that any suitable cross-section dimension and radius may be predetermined.

The magnetron 300 may further include a tuning assembly (not shown) for tuning the resonant mode spectrum of the anode. The tuning assembly may substantially correspond to the tuning assembly 201 of FIGS. 2A and 2B. When the magnetron 300 includes a tuning assembly, the cross-sectional shape and dimensions of the strap rings 313 may be determined so as not to disrupt the structural integrity of the shell 303 and vanes 304a, 304b that supports the tuning assembly in the vane. In particular, the separation distance between the cut-outs 221, 222 in the shell 303 and the vanes 304a, 304b needs to be sufficient to support the tuning assembly, and as such, a minimum separation distance therebetween must be provided, which will be determined based on the size of the magnetron. Accordingly, the cross-section of the strap rings 313 may be predetermined based on the separation distance between the cut-outs 221, 222 for the tuning assembly.

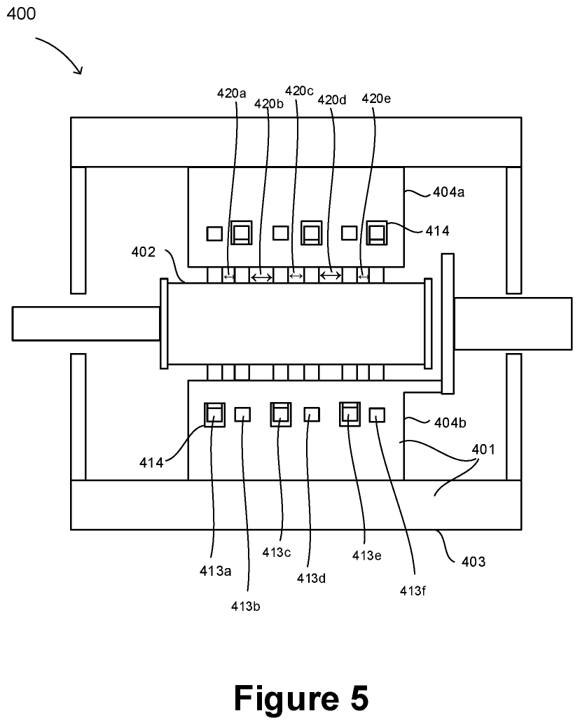

FIG. 5 shows a magnetron 400 according to a second example of the disclosure. The magnetron 400 illustrated in FIG. 5 includes an anode 401 and a cathode 402, whereby the anode 401 includes a shell 403 and first vanes 404a and second vanes 404b that alternate with one another angularly around the shell 403 in the manner described above with reference to FIG. 3. Accordingly, a detailed description of corresponding components is not provided with reference to FIG. 5.

The magnetron 400 includes a plurality of strap rings 413a, 413b, 413c, 413d, 413e, 413f (referred to collectively as strap rings 413), which pass through the holes 414 in the vanes 404a, 404b. Alternately arranged strap rings 413a, 413c, 413e couple the first vanes 404a, whilst the remaining strap rings 413b, 413d, 413f couple the second vanes 404b in much the same way as the strap rings 313 of the magnetron 300 of FIG. 3. However, the strap rings 413 of FIG. 5 differ from the strap rings 313 of FIG. 3, as follows: geometrically, the strap rings 413 are each the same, having identical cross-sectional profiles, and at least one interval between a first pair of adjacent strap rings is different from an interval between a second pair of adjacent strap rings. In the specific example of FIG. 5, interval 420a separates strap rings 413a and 413b; interval 420b separates strap rings 413b and 413c; interval 420c separates strap rings 413c and 413d; interval 420d separates strap rings 413d and 413e; and interval 420e separates strap rings 413e and 413f. Intervals 420a and 420e may be narrower than intervals 420b and 420d, and may differ from interval 420c. The intervals 420a, 420b, 420c, 420d, 420e, 420f will be referred to collectively as intervals 420. However, it will be understood that the disclosure is not limited to this, and one or more of the intervals may be different from the others. Moreover, the dimensions and arrangement of the holes 414 will be tailored and predetermined according to the dimensions and arrangements of the strap rings 413. In the specific embodiment of FIG. 5, the magnetron is operable to generate microwaves having frequencies in the S band (about 2 to 4 GHz), and the intervals 420 may be in the range of 3 to 5 mm. It will however be understood that any suitable interval may be predetermined based on the frequency range and/or power of the magnetron.

By providing non-uniformly distributed straps along the length of the vanes, the RF field produced across the vanes of the anode may be more uniformly distributed across the length of the anode vanes, as compared with magnetrons having uniformly distributed strap rings. Since the strength of the RF field generated in the magnetron may be relatively constant across the length of the vanes, this reduces the risk of localised heating occurring along the vanes, which could otherwise affect the electromagnetic field generated in the magnetron. Accordingly, this improves the electrical properties of the vanes of the anode and enables the overall RF field across the magnetron to be more accurately and precisely controlled to improve the power output by the magnetron. Furthermore, since the risk of localised heating along the vanes is significantly reduced, this reduces the risk of the vanes eroding over time, thereby improving the life span of the magnetron. Compared to magnetrons of the prior art, the distributed strapping technique of the present disclosure enables the use of multiple straps having tailored dimensions, thus improving stability and power handling capabilities. Accordingly, non-uniformly distributing the strap rings across the magnetron may give rise to the same smoothing of the RF field by a magnetron as the magnetron 360 having the variable geometric dimensions shown in FIG. 4.

In the specific example of FIG. 5, there is also an element of symmetry along the longitudinal axis of the vanes 404a, 404b, with adjacent strap rings separated by the same interval being arranged at opposite ends of the vanes. For example, first intervals 420a and 420e having the same separation are arranged at distal ends of the vanes 404a, 404b, whilst second intervals 420b and 420d having the same separation are arranged more centrally. In particular, the first intervals 420a and 420e are smaller than the second intervals 420b, 420d. In doing so, strap rings 413a and 413b having a smaller interval so as to be more closely together are arranged away from the centre of the vanes 404a, 404b, whilst strap rings 413c, 413d having a larger interval so as to be further apart are arranged more centrally along the lengths of the vanes 404a, 404b. This advantageously smooths the RF field along the lengths of the vanes 404a, 404b that would otherwise be concentrated centrally with respect to the vanes. As such, the vanes do not experience the same regions of concentrated RF fields that can cause them to overheat, thereby reducing the risk of the vanes eroding and improve the electromagnetic field produced for greater power output by the magnetron in use.

As was explained above, the strap rings 420 may be considered to belong to one of two groups, where each strap ring belonging to the same group of strap rings is in electrical contact with the same alternate anode vanes. That is, the first group of strap rings are in electrical contact with a first group of anode vanes 404a and the second group of strap rings are in electrical contact with a second group of anode vanes 404b. The strap rings 413a, 413c, 413e which are shown to be in contact with the anode vane 404a depicted in the upper half of FIG. 5 might be considered to belong to a first group of strap rings. The strap rings 413b, 413d, 413f which are shown to be in contact with the anode vane 404b depicted in the lower half of FIG. 5 might be considered to belong to a second group of strap rings. In some examples, different adjacent pairs of strap rings which belong to the same group of strap rings might have different intervals between each other. For example, the strap rings 413a and 413c are adjacent to each other in the first group of strap rings and have a first interval between them. The strap rings 413c and 413e are also adjacent to each other in the first group of strap rings and have a second interval between them. Whilst not clearly shown in FIG. 5, in some examples, the first interval may be different to the second interval, such that different pairs of adjacent strap rings in the same group of strap rings have different intervals between them.

The magnetron 400 may further include a tuning assembly (not shown) for tuning the resonant mode spectrum of the anode. The tuning assembly may substantially correspond to the tuning assembly 201 of FIGS. 2A and 2B. When the magnetron 400 includes a tuning assembly, the intervals between pairs of adjacent strap rings 413 may be determined so as not to disrupt the structural integrity of the shell 403 and vanes 404a, 404b that supports the tuning assembly in the vane. In particular, the separation distance between the cut-outs 221, 222 in the shell 403 and the vanes 404a, 404b needs to be sufficient to support the tuning assembly, and as such, a minimum separation distance therebetween must be provided, which will be determined based on the size of the magnetron. Accordingly, the intervals between adjacent pairs of strap rings 413 is restricted based on the separation distance between the cut-outs 221, 222 for the tuning assembly.

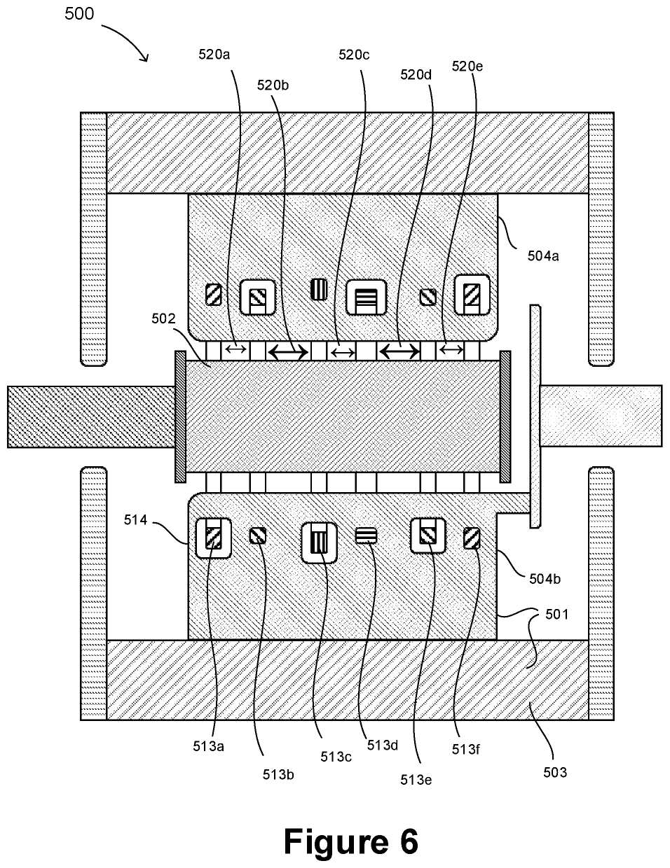

FIG. 6 shows a magnetron 500 according to a third example of the disclosure. The magnetron 500 illustrated in FIG. 6 includes an anode 501 and a cathode 502, whereby the anode 501 includes a shell 503 and first vanes 504a and second vanes 504b that alternate with one another angularly around the shell 503 in the manner described above with reference to FIG. 3. Accordingly, a detailed description of corresponding components is not provided with reference to FIG. 6.

The magnetron 500 includes a plurality of strap rings 513a, 513b, 513c, 513d, 513e, 513f (referred to collectively as strap rings 513), which pass through the holes 514 in the vanes 504a, 504b. Alternately arranged strap rings 513a, 513c, 513e couple the first vanes 504a, whilst the remaining strap rings 513b, 513d, 513f couple the second vanes 504b in much the same way as the strap rings 313 in the magnetron of FIG. 3. However, in the specific example of FIG. 6, the strap rings 513 vary geometrically, such that at least one strap ring 513 has a different cross-sectional profile and/or radius from the other strap rings 513, and the strap rings 513 are also distributed non-uniformly along the lengths of the vanes 504a, 504b, so that an interval 520a between a first adjacent pair of strap rings 513a, 513b differs from an interval 520b between a second pair of adjacent strap rings 513b, 513c. Accordingly, the magnetron 500 combines the features of the strap rings provided in FIGS. 3 and 5. Since the geometric variance has been described in relation to FIG. 3, and the non-uniform distribution with varying intervals 520a, 520b, 520c, 520d, 520e, 520f (referred to collectively as intervals 520) therebetween has been described in relation to FIG. 5, a detailed description is not provided with reference to FIG. 6. By varying the strap rings 513 both geometrically and non-uniformly across the magnetron 500, the smoothing of the RF field across the magnetron may be further improved.

Various examples have been described and depicted in which different strap rings have different cross-sectional profiles, areas, and/or dimensions. Such examples, have been described with reference to FIGS. 3, 5 and 6. In these examples, the strap rings have substantially uniform cross-sections around the entirety of the strap rings. That is, the cross-sectional dimensions, profiles etc. of a strap ring are substantially the same at each position around the strap ring. However, in other examples, a strap ring might have a different cross-section at different positions around a strap ring. For example, a strap ring might have a different cross-section at a position at which it is in electrical contact with an anode vane to its cross-section at a position at which the strap ring extends between anode vanes. It will be appreciated that from a functional perspective, the important part of a strap ring is the part which extends between alternate anode vanes with which it is electrically connected, since this is the portion which provides a path for RF currents between the anode vanes.

References herein to cross-sectional dimensions, profiles and/or areas etc of a strap ring may be taken to refer to at least the cross-sectional dimensions, profiles and/or areas etc. of a portion of the strap ring which extends between the vanes. In more detail, each strap ring may be considered to include first portions which extend between vanes with which they are in electrical contact with (each alternate vane) and second portions at which the strap ring is in direct contact with the vane. The second portions of the strap rings provide the electrical connections between the strap rings and each alternate vane for each strap ring (at the interface between the respective vanes and strap rings). The first portions of the strap rings provide the electrical connection between alternate vanes. References herein to strap rings having different cross-sectional dimensions, profiles and/or areas etc. may be taken to refer to strap rings having first portions (which extend between anode vanes) having different cross-sectional dimensions, profiles and/or areas etc. Accordingly a cross-sectional dimension, profile and/or area etc. of an electrical connection provided by a strap ring between alternate vanes may be different for different strap rings.

As described herein, a plurality of strap rings may be arranged such that one or more of a cross-sectional dimension of a strap ring, a radius of a strap ring and an interval to an adjacent strap ring is different for different strap rings. As a result of such an arrangement, a capacitance between a given strap ring and other strap rings in the anode (e.g. between a strap ring and an adjacent strap ring) may be different for different strap rings. Additionally or alternatively a capacitance between a given strap ring and another component of the anode (such as an anode vane) may be different for different strap rings. That is, a capacitance between different respective components of the anode may vary along the length of the anode as a result of variations in the strap rings as described herein (e.g. cross-sectional dimension, radius and/or intervals between strap rings). Such variations in capacitances may be used to provide an arrangement which serves to smooth the RF field distribution along the anode

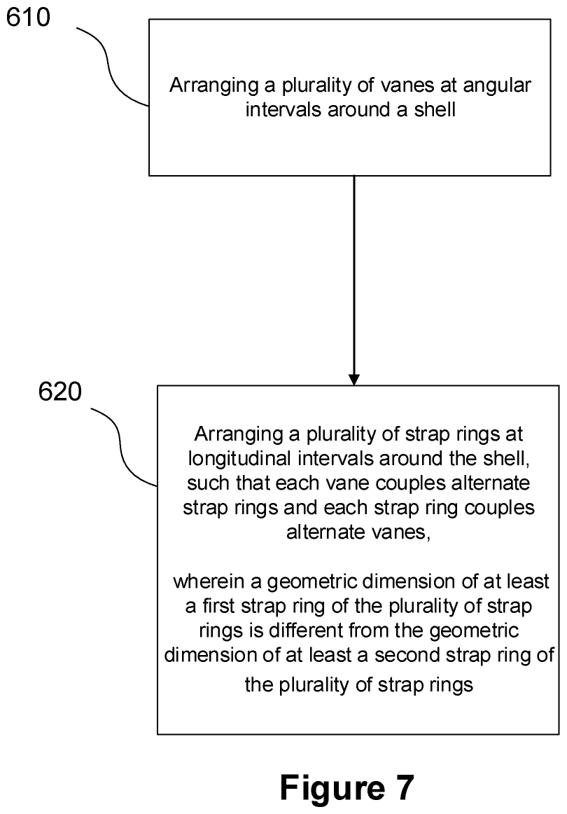

FIG. 7 shows a flow chart of a first example of a method for manufacturing an anode for a magnetron. The method may be used to manufacture the anode 301 of the magnetron 300 of FIG. 3.

The method includes steps of providing a generally cylindrical shell, a plurality of vanes and a plurality of strap rings, each of which may be substantially the shell 303, the vanes 304a, 304b and the strap rings 313 as described in relation to the first example of the disclosure in FIG. 3. In particular, the strap rings are provided, such that a cross-sectional dimension of at least a first strap ring of the plurality of strap rings is different from the cross-sectional dimension of at least a second strap ring of the plurality of strap rings. In step 610, the vanes are arranged at angular intervals around the shell 303 and extending radially inwardly from the shell 303, with the first vanes 304a alternating the second vanes 304b. An angular separation between each vane and its adjacent vane is for providing a cavity resonator. In step 620, the strap rings are arranged at longitudinal intervals and concentrically around the longitudinal axis of the shell, such that the first strap rings electrically connect the first vanes, and the second strap rings electrically connect the second vanes.

In the first example of the method, the strap rings may be arranged in any one of the manners discussed above in relation to FIG. 3. For example, strap rings 313a, 313f having a larger cross-section are arranged toward the distal ends of the vanes 304a, 304b, whilst strap rings 313b, 313e having smaller cross-sections are arranged more centrally with respect to the longitudinal direction of the vanes 304a, 304b.

In the first example of the method, the strap rings 313 are manufactured, although it will be understood that in other examples of the disclosure, the strap rings may be provided readymade. The strap rings are manufactured as follows in the first example of the disclosure.

The cross-sectional profiles of each strap ring are firstly predetermined according to computer/mathematical modelling. Once the dimensions are predetermined, the strap rings may be formed using any suitable forming tool. For example, a metal block comprising e.g. copper may be provided from which the strap rings are shaped and cut. In other examples, the strap rings may be formed using a mould, using any suitable mould-forming techniques.

In the first example of the method, the vanes are manufactured, although it will be understood that in other examples of the disclosure, the vanes may be provided readymade. The vanes are manufactured as follows in the first example of the disclosure.

Firstly, a plurality of metal cuboids are provided for forming the plurality of vanes. Each cuboid may be shaped, for example by cutting, to have a length and width corresponding to the desired length and width of the resulting vane. The plurality of cuboids are then divided in half to provide a first group of cuboids and a second group of cuboids, each having the same number of cuboids.

In the first example of the method, a first hole pattern is formed through a depth of the first group of cuboids, so as to form the first vanes 304a. Any suitable hole forming tool may be implemented to bore the holes through the cuboids. The first hole pattern includes the holes 314 described in relation to the first example of the disclosure. In particular, first holes and second holes alternate down the length of the vanes. Each first hole is dimensioned to have a cross-section corresponding to the cross-section of the respective strap ring passing therethrough, so as to enable the strap ring to pass therethrough whilst coupling to the respective vane. Each second hole is dimensioned to have a cross-section greater than the cross-section of the respective strap ring passing therethrough, so as to enable the strap ring to pass therethrough without coupling to the respective vanes. For ease of manufacture, the cross-section of each hole may be predetermined according to computer/mathematical modelling, prior to being formed.

Similarly, a second hole pattern is formed through a depth of the second group of cuboids, so as to form the second vanes 304b. The second hole pattern includes the holes 314 described in relation to the first example of the disclosure. In particular, first holes and second holes alternate down the length of the vanes. Each first hole is dimensioned to have a cross-section corresponding to the cross-section of the respective strap ring passing therethrough, so as to enable the strap ring to pass therethrough whilst coupling to the respective vane. Each second hole is dimensioned to have a cross-section greater than the cross-section of the respective strap ring passing therethrough, so as to enable the strap ring to pass therethrough without coupling to the respective vanes.

However, it will be understood that the vanes may be formed by any other suitable method, such as by using additive manufacturing techniques.

In the first example of the method, the intervals between each first hole and its adjacent second hole in the vanes 304a, 304b is the same, such that when the strap rings 313 pass therethrough, the strap rings 313 are uniformly arranged along the lengths of the vanes.

In the first example of the method, the strap rings 313 are cut so as to include at least one break therethrough, although the strap rings 313 may otherwise be formed to have a break therethrough. Each strap ring 313 can then be threaded through the holes 314 formed in the vanes 304a, 304b so as to arrange the strap rings 313 and the vanes 304a, 304b together, using for example a jig.

In the first example of the method, the shell 303 is marked with indicators corresponding to the positions of where the vanes 304a, 304b are to be arranged around the shell, so that the vanes may be placed accurately at their intended position. For example, the shell 303 may include grooves for seating the vanes 304a, 304b. In such examples, the method may include forming the grooves in an inner wall of the shell 303, using any suitable groove forming technique. The vanes 304a, 304b together with the strap rings 313 passing therethrough are then arranged with the shell 303. In particular, the vanes are arranged at angular intervals around the shell 303, with the first vanes 304a alternating the second vanes 304b, using for example the jig. The arranged shell 303 with the strap rings 313 and vanes 304a, 304b are then soldered/brazed together at a suitable temperature so as to form the anode 301.

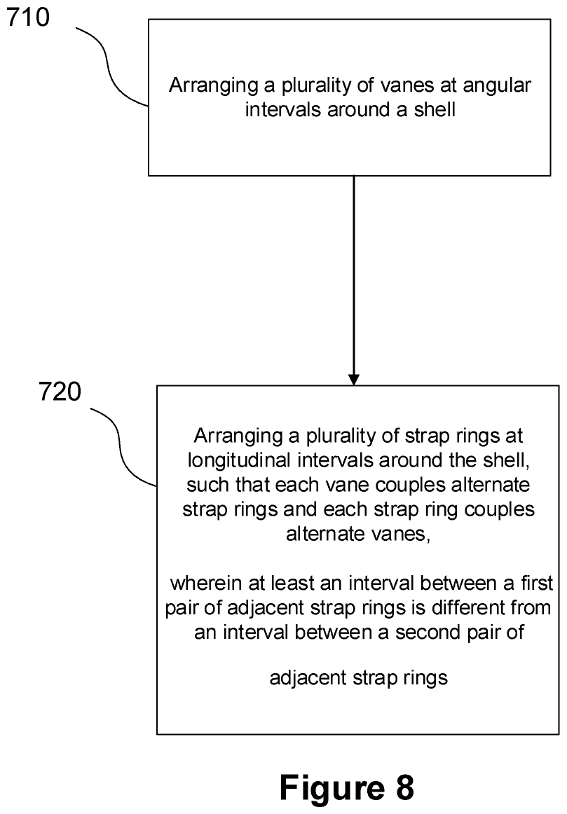

FIG. 8 shows a flow chart of a second example of a method for manufacturing an anode for a magnetron. The method may be used to manufacture the anode 401 of the magnetron 400 of FIG. 5.

The method includes steps of providing a generally cylindrical shell, a plurality of vanes and a plurality of strap rings, each of which may be substantially the shell 403, the vanes 404a, 404b and the strap rings 413 as described in relation to the second example of the disclosure in FIG. 5. In step 710, the vanes are arranged at angular intervals around the shell 403 and extending inwardly from the shell 403, with the first vanes 404a alternating the second vanes 404b. An angular separation between each vane and its adjacent vane is for providing a cavity resonator. In step 720, the strap rings are arranged at longitudinal intervals and concentrically around the longitudinal axis of the shell, such that a first group of strap rings electrically connect the first vanes, and a second group of strap rings electrically connect the second vanes, and at least an interval between a first pair of adjacent strap rings is different from an interval between a second pair of adjacent strap rings.

In the second example of the method, the strap rings may be arranged in any one of the manners discussed above in relation to FIG. 5. For example, strap rings 413 may be arranged such that interval 420a between adjacent strap rings 413a, 413b arranged toward the distal ends of the vanes is smaller than interval 420b between adjacent strap rings 413b, 413c arranged more centrally with respect to the longitudinal direction of the vanes.

In the second example of the method, the strap rings 413 are manufactured, although it will be understood that in other examples of the disclosure, the strap rings may be provided readymade. In the second example of the method, the strap rings 413 are manufactured to each have the same cross-sectional profile and dimensions, and may be formed using any suitable forming or moulding technique.

In the second example of the method, the vanes 404a, 404b are manufactured, although it will be understood that in other examples of the disclosure, the vanes may be provided readymade. The vanes 404a, 404b are manufactured as follows in the second example of the disclosure.

The arrangement of each strap ring is firstly predetermined according to computer/mathematical modelling. In particular, the intervals 420 between each strap ring and its adjacent strap ring is predetermined. Once the intervals 420 have been predetermined, the vanes 404a, 404b may be formed.

Firstly, a plurality of metal cuboids is provided and divided equally into first group and a second group, as in the first example of the disclosure described above.

In the second example of the disclosure, a first hole pattern is formed through a depth of the first group of cuboids, so as to form the first vanes 404a. Any suitable hole forming tool may be implemented to bore the holes through the cuboids. The first hole pattern includes the holes 414 described in relation to the first example of the disclosure. In particular, first holes and second holes alternate down the length of the vanes, and are arranged at intervals corresponding to the intervals 420 predetermined for the strap rings 413. Each first hole is dimensioned to have a cross-section corresponding to the cross-section of the respective strap ring passing therethrough, so as to enable the strap ring to pass therethrough whilst coupling to the respective vane. Each second hole is dimensioned to have a cross-section greater than the cross-section of the respective strap ring passing therethrough, so as to enable the strap ring to pass therethrough without coupling to the respective vanes.

Similarly, a second hole pattern is formed through a depth of the second group of cuboid, so as to form the second vanes 404b. The second hole pattern includes the holes 414 described in relation to the first example of the disclosure. In particular, first holes and second holes alternate down the length of the vanes, and are arranged at intervals corresponding to the intervals predetermined for the strap rings. Each first hole is dimensioned to have a cross-section corresponding to the cross-section of the respective strap ring passing therethrough, so as to enable the strap ring to pass therethrough whilst coupling to the respective vane. Each second hole is dimensioned to have a cross-section greater than the cross-section of the respective strap ring passing therethrough, so as to enable the strap ring to pass therethrough without coupling to the respective vanes.

In the second example of the disclosure, each of the first holes in the vanes 403a, 403b have the same cross-sectional profile, and each of the second holes in the vanes 403a, 403b have the same cross-sectional profile that is larger than the cross-sectional profile of the first holes.

The strap rings 413 may then be arranged and brazed together with the vanes 404a, 404b and the shell 403 to form the anode 401, in substantially the same way as that described above in relation to the first example of the method of FIG. 7.

A third example of the method (not shown) may be used for manufacturing anodes of a magnetron, whereby at least one strap ring has a different geometric dimension to the geometric dimension of the remaining strap rings, and an interval between a first pair of adjacent strap rings is different from an interval between a second pair of adjacent strap rings. The third method may be used to manufacture the anode 501 of the magnetron 500 shown in FIG. 6.

The third method includes steps that combine the first and second methods of FIGS. 7 and 8 described above. In particular, the third method includes the steps of providing the strap rings 513 to have different geometric dimensions (e.g. cross-sectional profiles and/or radii) in the manner described above in relation to FIG. 7, and provides the vanes 504a, 504b having holes with non-uniformly arranged intervals, as described above in relation to FIG. 8. The strap rings 513, vanes 504a, 504b and shell 503 may then be assembled and soldered together to form the anode 501 in substantially the manner described above in relation to FIGS. 7 and 8. Accordingly, a detailed description of the corresponding steps is not provided with reference to the third method.

The anodes formed by the first, second and third methods, respectively, may then be assembled in respective magnetrons. For example, the anode 301 may be assembled in the magnetron 300, the anode 401 may be assembled in the magnetron 400, and the anode 501 may be assembled in the magnetron 500.

There is provided herein an anode (301) for a magnetron (300), the anode comprising: a cylindrical shell (303) defining a longitudinal axis, a centre of the shell for accommodating a cathode (302) of the magnetron; a plurality of vanes (304a, 304b) arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and a plurality of annular strap rings (313) for setting a resonant mode spectrum of the cavity resonator, wherein the strap rings are arranged at longitudinal intervals and concentrically with the longitudinal axis of the shell, wherein alternate vanes are configured to support alternate strap rings, such that each vane couples alternate strap rings and each strap ring couples alternate vanes, wherein a cross-sectional dimension of at least a first strap ring of the plurality of strap rings is different from the cross-sectional dimension of at least a second strap ring of the plurality of strap rings.

There is also provided herein an anode (401) for a magnetron (400), the anode comprising: a cylindrical shell (403) defining a longitudinal axis, a centre of the shell for accommodating a cathode (402) of the magnetron; a plurality of vanes (404a, 404b) arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and a plurality of annular strap rings (413) for setting a resonant mode spectrum of the cavity resonator, wherein the strap rings are arranged at longitudinal intervals and concentrically with the longitudinal axis of the shell, wherein alternate vanes are configured to support alternate strap rings, such that each vane couples alternate strap rings and each strap ring couples alternate vanes, wherein at least an interval (420) between a first pair of adjacent strap rings is different from an interval between a second pair of adjacent strap rings.

Variations of the described embodiments are envisaged. For example, all of the features disclosed in this specification (including any accompanying claims, abstract and drawings), and/or all of the steps of any method or process so disclosed, may be combined in any combination, except combinations where at least some of such features and/or steps are mutually exclusive.

References herein to radio frequencies may be taken to mean any frequency between about 30 Hz and 300 GHz. Radio frequencies are expressly intended to include microwave frequencies. References herein to microwave frequencies may be taken to mean any frequency between about 300 MHz and 300 GHz.

Examples of magnetrons contemplates herein may be operable to generate microwaves having frequencies in the S band (about 2 to 4 GHz), the C band (about 4 to 8 GHz) and/or the X Band (about 8 to 12 GHz). In some examples, a magnetron may be operable to generate microwaves having frequencies greater than about 3 GHz. The magnetron may be operable to generate microwaves having frequencies of less than about 12 GHz.

All ranges and values (e.g. values and/or ranges of power and/or frequency) provided herein are provided for illustrative purposes only and should not be interpreted to have any limiting effect.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An anode for a magnetron, the anode comprising:
a cylindrical shell defining a longitudinal axis, a centre of the shell for accommodating a cathode of the magnetron;
a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and
a plurality of annular strap rings for setting a resonant mode spectrum of the cavity resonator, wherein the strap rings are arranged at longitudinal intervals and concentrically with the longitudinal axis of the shell,
wherein alternate vanes are configured to support alternate strap rings, such that each vane couples alternate strap rings and each strap ring couples alternate vanes,
wherein a cross-sectional dimension of at least a first strap ring of the plurality of strap rings is different from the cross-sectional dimension of at least a second strap ring of the plurality of strap rings.

2. The anode of claim 1, wherein the cross-sectional dimension of the at least a first strap ring is different from the cross-sectional dimension of the at least a second strap ring at least in a portion of the strap rings which extend between alternate anode vanes.

3. The anode of claim 1, wherein at least an interval between a first pair of adjacent strap rings is different from an interval between a second pair of adjacent strap rings.

4. The anode of claim 1, wherein a radius of at least one strap ring of the plurality of strap rings is different from the radius of at least another strap ring of the plurality of strap rings.

5. The anode of claim 1, wherein the strap rings have a cross-section that is at least one of substantially square and rectangular shaped.

6. The anode of claim 1, wherein each strap ring is arranged across the shell according to a predetermined arrangement, based on a cross-sectional dimension of each strap ring.

7. The anode of claim 1, wherein the first strap ring has a cross-sectional dimension that is greater than the second strap ring, wherein the first strap ring is arranged toward a longitudinal end of the respective vanes.

8. The anode of claim 7, wherein the second strap rings is arranged more centrally along the length of the respective vanes than the first strap ring.

9. The anode of claim 1, wherein the cross-sectional dimension of at least the first strap ring is predetermined for causing a radio frequency, RF, field across a vane, when generated by the cathode of an activated magnetron, to be uniformly distributed across the length of the vane.

10. The anode of claim 1, wherein the plurality of annular strap rings includes a first group of strap rings coupled to a first subset of the vanes and a second group of strap rings coupled to a second subset of the vanes, and wherein the at least a first strap ring and the at least a second strap ring belong to the same of the first or second group of strap rings.

11. An anode for a magnetron, the anode comprising:
a cylindrical shell defining a longitudinal axis, a centre of the shell for accommodating a cathode of the magnetron;
a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and
a plurality of annular strap rings for setting a resonant mode spectrum of the cavity resonator, wherein the strap rings are arranged at longitudinal intervals and concentrically with the longitudinal axis of the shell,
wherein alternate vanes are configured to support alternate strap rings, such that each vane couples alternate strap rings and each strap ring couples alternate vanes,
wherein an interval between a first pair of adjacent strap rings is different from an interval between a second pair of adjacent strap rings.

12. The anode of claim 11, wherein at least one of a cross-sectional dimension and a radius of at least a first strap ring of the plurality of strap rings is different from the respective cross-sectional dimension and the radius of at least a second strap ring of the plurality of strap rings.

13. The anode of claim 11, wherein the first pair of adjacent strap rings is arranged more centrally in the magnetron than the second pair of adjacent strap rings, wherein the interval between the first pair of adjacent strap rings is greater than the interval between the second pair of adjacent strap rings.

14. The anode of claim 11, wherein the intervals between the strap rings are predetermined for causing a radio frequency, RF, field across a vane, when generated by the cathode of an activated magnetron, to be uniformly distributed across the length of the vane.

15. An anode for a magnetron, the anode comprising:
a cylindrical shell defining a longitudinal axis, a centre of the shell for accommodating a cathode of the magnetron;
a plurality of vanes arranged at angular intervals around the shell, wherein an angular separation between each vane and its adjacent vane is configured to provide a cavity resonator of the magnetron, wherein each vane has a width extending radially inwardly from the shell toward the centre of the shell, and has a length extending longitudinally in parallel with the longitudinal axis of the shell; and
a plurality of annular strap rings for setting a resonant mode spectrum of the cavity resonator, wherein the strap rings are arranged at longitudinal intervals and concentrically with the longitudinal axis of the shell,
wherein alternate vanes are configured to support alternate strap rings, such that each vane couples alternate strap rings and each strap ring couples alternate vanes,
wherein a radius of at least a first strap ring of the plurality of strap rings is different from the radius of at least a second strap ring of the plurality of strap rings.

16. The anode of claim 15, wherein a cross-sectional dimension of at least a first strap ring of the plurality of strap rings is different from the cross-sectional dimension of at least a second strap ring of the plurality of strap rings.

17. The anode of claim 15, wherein an interval between a first pair of adjacent strap rings is different from an interval between a second pair of adjacent strap rings.

18. The anode of claim 15, wherein the radius of at least the first strap ring is predetermined for causing a radio frequency, RF, field across a vane, when generated by the cathode of an activated magnetron, to be uniformly distributed across the length of the vane.

19. The anode of claim 15, wherein the plurality of annular strap rings includes a first group of strap rings coupled to a first subset of the vanes and a second group of strap rings coupled to a second subset of the vanes, and wherein the at least a first strap ring and the at least a second strap ring belong to the same of the first or second group of strap rings.
